(19) United States
(12) Patent Application Publication
(10) Pub. No.: US 2011/0302962 A1
(43) Pub. Date: Dec. 15, 2011

(54) METHOD FOR PRODUCING CLEAR GLASS OR CLEAR DRAWN GLASS BY UTILIZING A SPECIAL REFINING PROCESS

(76) Inventors: Artur Gattermann, Duingen (DE); Ralph Seuwen, Schwabenheim (DE); Lothar Niessner, Duingen (DE); Stefan Schmitt, Stadecken-Elsheim (DE)

(21) Appl. No.: 13/156,713

(22) Filed: Jun. 9, 2011

(30) Foreign Application Priority Data
Jun. 9, 2010 (DE) 10 2010 023 176.2

(51) Int. Cl. C03B 5/225; C03B 17/00; C03B 15/00

(52) U.S. Cl. 65/29.21; 65/66; 65/29.12

(57) ABSTRACT

A method to produce a clear glass or a clear drawn glass includes the steps of melting starting materials to obtain a glass batch melt, refining the obtained glass batch melt, homogenizing the obtained glass batch melt, and producing a glass product in the drawing process. A sulfate refining agent, selected from an alkali-, alkaline earth- or zinc sulfate or mixtures thereof is utilized in a predetermined amount and a predefined refining temperature during refining of the glass batch melt which is 0° C. to 100° C. higher than that in a refining process using a refining system which contains antimony oxide on its own or in combination with one or several other refining agents.

### BACKGROUND OF THE INVENTION

1. Field of the Invention

The present invention relates to a method to produce clear glass or clear drawn glass by utilizing special process parameters and a special refining process.

2. Description of the Related Art

Flat glass is glass which, in spite of the manufacturing process, is produced in flat form. Flat glass is currently produced essentially in two methods: the float glass method and the rolling method.

A large part of flat glass is currently produced with the float glass method. Float glass is generally transparent soda-lime glass. For production, the raw materials are melted as a batch at a temperature of 1500° C. and the glass melt is led through a channel onto a liquid level tin bath under an inert gas atmosphere (float bath). The lighter glass melt then swims, or floats to the surface of the liquid metal. Here, the characteristic of metals, like that of all liquids, to form a completely smooth surface in their liquid state on the surface due to surface tension becomes advantageous. Tin, at 238° C. moreover has a significantly lower melting point than the deformation point of the glass, and it is approximately three times as heavy as glass. Therefore, the glass swims on the liquid tin and forms a completely plane-parallel glass surface on both sides. In the float glass process the liquid glass lays on the ideal smooth surface of the liquid tin and solidifies in perfect surface quality as finished glass, while the tin with its much lower melting point remains liquid (see Technik der Glasherstellung, Günther Nölle Verlag, 3. revised edition, Deutscher Verlag für Grundstoffundustrie Stuttgart. Page 144-145 and SCHOTT Glaslexikon, H. G. Pfaender, 5. Edition, mvg Verlag moderne Industrie, AG, Landsberg am Lech, 1997, pages 56 ff).

Cast glass is obtained through rolling of the glass. Production occurs discontinuously through casting onto a plate and rolling out, or after continuously flowing from a trough, by forming between rolls. Compared to float glass, the roll process leads to a rough surface of the glass with a lower rigidity (see Technik der Glasherstellung, Günther Nölle, 3. Revised edition, Deutscher Verlag für Grundstoffundustrie Stuttgart, 1997, page 142-144 and Flachglas, Walter König und Lambert v. Reis und Rudolf Simon, Akademische Verlagsgesellschaft M. M. H. Leipzig, 1934, page 43 ff.)

A third method to produce flat glass, which is no longer of the same significance than the float and roll method, is the so-called drawing technique with which sheet glass, window glass, glass for pictures, etc., and especially specialty glass types, can be produced. Drawn glass is produced as a rule in a continuous drawing process, by means of a mechanical device (see Technik der Glasherstellung, Günther Nölle, 3. Revised edition, Deutscher Verlag für Grundstoffundustrie, Stuttgart, 1997, page 145-149 and Flachglas, Walter König and Lambert v. Reis and Rudolf Simon, Akademische Verlagsgesellschaft M>B>H. Leipzig, 1934, page 1ff.)

Today, drawn glass is replaced to a great extent by float glass and is only produced in small volumes. This would apply, for example, to specialty glasses which are difficult or impossible to produce in the float process or which have to meet special requirements. Exemplary specialty glasses which are difficult or impossible to produce in the float process include, for example, very thin glasses, especially for LCD monitors and cased glasses, specifically glasses which are encased with a second glass layer.

In the production of drawn glass, a batch of various starting materials is initially provided, possibly together with recycling glass or shards stemming from production breakages. The glass batch is placed in a melting tank where a glass melt is produced at temperatures of 1470° C. or higher. Following the melting area is the refining area. In other words, the glass is refined as soon as it has melted. In glass production, the term refining refers to degassing and expulsion of bubbles from the melted glass. Bubbles are defects in the glass and must be removed in order to ensure an appropriate glass quality free of high foreign gas content and bubbles. Bubbles in the glass melt have a tendency of rising to the surface. Since the speed of the rising bubbles depends on their diameter, large bubbles rise quicker than smaller bubbles. The basic principle in refining is therefore the entertainment of the smaller bubbles by the larger, faster rising bubbles. This means that additional gas bubbles are introduced into the glass in order to facilitate rising of the gas bubbles which are present in the glass and to thereby remove them. The behavior of gases or respectively bubbles in the glass melt, as well as their removal, is described for example in “Glastechnische Fabriktionsfehler”, published by H. Hebsen-Marwedel and R. Brückner, 3. Edition, 1980, Springer Verlag, page 195 ff.

Small bubbles do not rise fast enough in the viscous glass mass, so supportive measures are necessary in order to facilitate this in an economical period of time. An example of this is physical or mechanical refining, whereby the bubble content is reduced through injection of gasses, such as water vapor, oxygen, nitrogen or air through openings in the floor of the melting tank (“Bubbling”).

Other than physical or mechanical refining, chemical refining is based on decomposition and evaporation of one or several compounds, thereby creating a gaseous phase in a certain temperature range. By releasing an additional gaseous phase, the volume of the existing bubbles is enlarged and the buoyancy of the bubbles increased, so that the desired refining effect can be provided. In industrial glass production in glass melting tanks, chemical refining has hitherto been of importance. Here, refining generally occurs through addition of refining agent(s) in the glass batch.

Due to the high viscosity of the melt, refining occurs usually very slowly, and as a rule equally as high or even higher temperatures than in the melt area are necessary. Usual temperatures for refining are therefore in the range of the melting temperature, in other words, around 1470° C. or higher. Refining is determinative for the glass quality and therefore of decisive importance.

Known refining agents in the production of drawn glass are, for example, redox-refining agents, such as antimony oxide or arsenic oxide. Also known are other polyvalent ions which occur in at least two oxidation states. Also known are evaporation refining agents, that is compounds which due to their vapor pressure are volatile at the high temperatures, such as chlorides, for example sodium chloride and fluorides.

After the refining area, the glass is formed at lower temperatures than smelting and refining of the glass. Depending on the desired product, the glass can be formed differently in the formation process. In the current example, the forming process is a drawing process. A surface treatment process and/or finishing process may possibly follow after the forming process.

In a continuous method for the production of a drawn glass—if for example an industrial scale is applied—the sequence of the described process steps is not separated from each other chronologically, but spatially. The volume of the supplied glass batch, as a rule, is consistent with the volume of the glass yield.

It has now been shown that the use of antimony oxide as a refining agent is disadvantageous. Antimony is a heavy metal. Heavy metals are however a health hazard, or respectively toxic for the human organism since they cannot be metabolized in the body and therefore cannot be broken down. Due to their cumulative effects, heavy metals are, as a rule, chronic toxins in small traces which enrich themselves for example in bones, teeth and in the brain and which can impair the functionality of the nervous system. Immune defenses can also be damaged.

Moreover, increasing environmental requirements lead to demands to forgo harmful substances, for example arsenic, antimony or lead in the glass. Heavy metals can be toxic not only to the human body, but also for the environment, specifically plant matter and animals. Therefore heavy metals should be avoided as much as possible in order to rule out health risks and to prevent burdening the environment. It is also of importance not to use other harmful refining agents, for example arsenic oxide. Known refining agents, such as for example cerium oxide, are also costly.

Since refining has a significant influence upon the quality of the drawn glass which is to be produced, the selected refining agent should in every case meet the high demands put upon refining agents, which means that it is necessary to ensure an as great as possible freedom from bubbles in the melt and the drawn glass produced from it.

Accordingly, what is needed in the art is a method for producing clear drawn glass by foregoing heavy metal refining agents, especially refining agents such as antimony oxide and arsenic oxide, but nevertheless to refine the glass melt as effectively as possible, so that the result is a high quality glass with very few or no bubbles. Moreover, a method is needed to provide refining of the glass melt as cost effectively as possible.

### SUMMARY OF THE INVENTION

The present invention provides a method to produce clear glasses or clear drawn glasses, which includes the following steps:

a) Melting starting materials to obtain a glass batch melt;

b) Refining the obtained glass batch melt;

c) Homogenizing the obtained glass batch melt; and

d) Producing a glass product in the drawing process.

According to the method of the present invention, sulfate refining agents, selected from an alkali-, alkaline earth- or zinc sulfate, or mixtures thereof, are utilized in a predetermined amount at a predefined refining temperature during refining of the glass batch melt. The predefined refining temperature is in a range between approximately 0° C. to 100° C. higher, for example approximately 30° C. to 60° C. higher, than that in a refining process using a refining system which contains antimony oxide on its own or in combination with one or several other refining agents.

The method to produce clear glasses or clear drawn glasses according to the present invention includes the process steps of melting the starting materials for the glass which is to be produced, refining the obtained glass melt, homogenizing and, possibly, subsequent conditioning of the glass, as well as production of the desired glass product by utilizing the drawing process.

Initially, the starting materials are selected for the glass and a mixture of the various raw materials is provided in the form of a batch. The raw material components are determined by the type of glass (glass series) which is to be produced. In order to accelerate the melt, components of glass shards can be added to the glass batch. The component portion of glass shards is dependent on the desired glass quality and the availability and may, for example, be between 20% and 75%. The glass batch production can be done in batch quantities or continuously on a small or large industrial scale. On a large industrial scale the glass batch production is completely automated.

The prepared glass batch is then delivered into a melting device. According to the method of the present invention, melting the glass batch may occur in a melting tank, for example in a continuous tank (see Glasschmelzöfen, W. Trier, Springer Verlag, Berlin Heidelberg New York Tokyo, 1984, page 1 ff.). With a continuous tank the production is continuous. In other words, the glass batch is supplied into it, is melted and the molten glass is removed from it. The energy for the melting tank is provided, for example, by an oil and/or gas fueled burner. Air (air fuel) or oxygen (oxy-fuel) can be used as an oxidant. The serviceable life of a melting tank can be several years.

Following the melting area is the refining area. As is known, mass produced glasses refined with sulfate generally do not meet the high quality requirements of specialty flat glasses. In float and rolled glass the general values regarding bubbles in the glass are in the range of 10 bubbles/kilograms (kg) glass and higher (DIN EN Glass for building industry 572-1, 572-2, 572-4). The specifications/requirements with regard to bubbles for specialty flat glasses is normally around 5/kg and clearly less. According to the method of the present invention, heavy metal refining agents, such as antimony oxide or other harmful refining agents, for example arsenic oxide, can be completely eliminated and replaced by a sulfate refining agent like alkali-, alkaline earth- or zinc sulfate, or mixtures thereof, and that nevertheless refining is achieved, such that the specifications/requirements for specialty glasses are met. The pure sulfate refining according to the present invention therefore offers the advantage of avoidance of heavy metals of all types and simultaneous high quality of the produced drawn glass with appropriately few or no bubbles. The health and environment related advantages of avoiding heavy metals are therefore clear.

To achieve the desired refining result in the glass melt, the sulfate refining method according to the present invention requires frequent raising of the temperature during refining in order to ensure the desired freedom from bubbles and to preclude a possible foam formation or, respectively, to counteract the temperature drop due to foam formation. As a rule, a temperature of 1470° C. is required during refining when antimony oxide is the refining agent. According to the present invention, the refining temperature is increased around 0° C. to 100° C., for example approximately 30° C. to 60° C., compared with the known refining process which uses an identical glass composition and identical process control with the exception of the refining agent, namely an antimony oxide refining agent, for example in antimony oxide/sulfate refining. According to the invention, therefore temperatures in the range of approximately 1480° C. to 1570° C., for example approximately 1500° C. to 1530° C., are used for pure sulfate refining.

Glass compositions can also be produced according to the present invention which can be refined to a sufficient extent without raising the refining temperature. For such instances an increase in the refining temperature of 0° C. is cited.

The energy supply during the production process according to the present invention may only be increased during the refining process which means that the temperature during the refining process is increased by approximately 0° C. to 100° C., for example 30° C. to 60° C., compared to conventional refining with antimony oxide or when using antimony oxide/sulfate refining agents. According to the present invention, the energy supply in the melting area, that is the melting temperature itself, is, for example, not increased. Since smelting and refining according to the present invention may take place in the same melting tank, the energy supply, in other words the temperature increase, proceeds from the front part of the melting tank where the glass batch is melted through to the back part of the melting tank where refining occurs. This can be achieved, for example, through appropriate adjustment and arrangement of the utilized burners at the melting tank. There are, however, also glass compositions where it is advantageous to use a different energy supply.

For refining according to the method of the present invention, not only the energy supply, in other words the supply of energy into the melting tank, is of importance, but also the energy distribution in the melting tank. The melting tank may be configured so that an energy distribution occurs in the melting tank which is useful for the refining process.

Sulfates which can be used according to the present invention include sodium-, potassium-, calcium-, barium- or zinc sulfate. During sulfate refining the utilized sulfate refining agent reacts as follows with the generally present SiO₂ when forming SO₃:

RSO₄+SiO₂→RO×SiO₂+SO₃

R₂SO₄+SiO₂→R₂O×SiO₂+SO₃

In the above equations, “R” represents an alkaline earth metal and “R₂” represents an alkaline metal.

SO₃ then reacts further to SO₂ and ½ O₂, which represent the actual refining reagents. The effect of the sulfate refining agent is greatly dependent on the solubility of SO₃ or respectively SO₄²⁻ in the glass melt. The solubility of the gas in the glass, gas bubble formation due to the refining agent and the viscosity of the glass melt are greatly temperature dependent. The gases released from the refining agent in the form of bubbles enlarge the smaller gas bubbles remaining from the melting process, thereby enabling their rise and, thus, removal from the melt. It is, however, necessary that enough refining gas is dissolved in the glass in order to be released at the higher temperature, the refining temperature.

When using an alkaline-, alkaline earth- or zinc sulfate as refining agent, the sulfate decomposes as described above into oxide and SO₃, resulting, for example in CaSO₄ from approximately 100 weight %, in CaO from approximately 41.19 weight % and SO₃ approximately from 58.81 weight %.

According to the present invention, the addition of sulfate refining agents, calculated as SO₃ may, for example, be in a range between approximately 0.2-1.5 weight %, or in a range between approximately 0.7-1.2 weight %.

Further, the amount of sulfate refining agent may be established according to the following steps:
(1) Measuring the released gas volume of a reference synthesis according to a standard measuring procedure, whereby the refining agent contains antimony and sulfate, as a function of the temperature and determining therefrom the total released refining-relevant gas volume;
(2) Measuring the released gas volumes of syntheses with pure sulfate refining under the same process conditions and the same glass composition and the same standard measuring procedure as was used for the reference-synthesis as a function of the temperature, respectively adding different amounts of sulfates and therefrom determining the total released gas volume (SO₂+O₂); and
(3) Determining the amount of sulfate refining agent to be used based on the values determined in step (1) and step (2).

The term “refining-relevant” means—that gas volume which is a contributory factor in refining, in other words SO₂+O₂ in a certain temperature range.

The amount of sulfate refining agent to be used in step (3) may then be established through:
(a) Generating a curve based on the released gas volume (SO₂+O₂) as a function of the respectively used amount of sulfate (SO₃) according to step (2);
(b) Furnishing the determined total released gas volume as a function of the used amount of sulfate (SO₃) for the reference according to step (1); and
(c) Reading the amount of sulfate (SO₃) which is to be used which is present in the same total released gas volume (SO₂+O₂) as in the reference.

More specifically, according to the method of the present invention:
(1) First, the released gas volume is measured as a function of the temperature for a reference synthesis. In this reference-synthesis the process conditions and the glass composition are selected as desired within the usual range, whereby the refining agent contains antimony and sulfate. This measurement serves as a reference. Based on the measured gas release, the calculation of the released total gas volume can occur in the relevant temperature range (from beginning of refining to the maximum achieved glass temperature, i.e. between approximately 1250 and 1470° C.) for the planned synthesis.
(2) Then the measurement of the gas release is conducted under the same process conditions and the same glass compositions as for the reference synthesis, however by using a refining agent or agents which contains or contain only sulfate, but no antimony. Based on the measured gas release the calculation of the released total gas volume can be carried out again in the analog temperature range as was done in the reference (from beginning of refining to the maximum achieved glass temperature, i.e. between approximately 1250 and 1470° C.). This total gas release is implemented for various amounts of the sulfate refining agents, so that the total released gas volume is determined respectively for a given amount of sulfate refining agent.

Where applicable, it can be advantageous to consider if sulfate- or antimony-containing starting materials are used for the glass production. This may play a role, for example, if waste glass or respectively shards are added. Sulfate contained in shards, for example, does not play a role since newly added sulfate no longer effectively refines as long as the melting temperature is not raised above the maximum point through which the shards have passed during the prior melting process. However, reused antimony is of importance since its refining effectiveness is around 80 to 100%, so it must necessarily be considered.

The measurement of the gas release may, for example, be conducted on batches with gas profile measurements. With a heating rate, for example, of 6 Kelvin/minute (K/min) various batch combinations can be heated and the gas emission can be determined to a temperature of, for example, approximately 1690° C. by means of mass spectroscopy. As a rule, 30 gram (g) batches are weighed into a silica glass cuvette (φ80, height 50 mm). In order to be able to measure the emission chronologically as closely as possible to its origin, the cuvette is supplied, for example, with a flushing gas stream of 10 milliliters/minute (mL/min) argon. The emissions of carbon dioxide (CO₂), sulfur dioxide (SO₂) and oxygen (O₂) can then also be established quantitatively. Moreover, nitrogen oxides (NOₓ) and water vapor were also proven qualitatively. Gas development in dependence on batch temperature was recorded. In other words, the temperature ranges of the disintegration of the nitrates, carbonates and sulfates can be recorded, as well as the release of absorbed and chemically combined (as hydrate) water. In the measurement, attention was given to the ratio of SO₂ and O₂⁻ release in the temperature range of the sulfate refining (>1100° C.) (“refining-relevant gas volume”). For this purpose, batch combinations having different sulfur contents (for example 0-2 weight % SO₃) with different alkaline- and alkaline earth compounds as sulfate carrier were examined. For additional details see for example F.W. “Gasprofilmessungen zur Bestimmung der Gasabgabe beim Glasschmelzprozess”, Glastechn. Berichte 53 (1980), 177-188.
(3) Through correlation of the determined total released gas volume with the used amount of sulfate refining agent, the amount of sulfate refining agent to be used for pure sulfate refining can be determined, based on the reference in order to achieve a gas release which was achieved for the selected reference. For this purpose, a curve was prepared in which the total released gas volume (SO₂+O₂) is applied as a function of the respective sulfate amount (SO₃), as was established in Step (2). The determined total released gas volume is then drawn into the diagram as a function of the amount of sulfate (SO₃) used for the reference, determined according to step (1). Then the sulfate amount (SO₃) to be used, which is present in the same total released gas volume (SO₂+O₂) as in the reference can be read.

According to the method of the present invention, the maximum required melting-/refining temperature for sulfate refining is established with the following steps:
(1′) Measuring the released gas for the reference synthesis according to a standard measuring procedure, whereby the refining agent contains antimony and sulfate, as a function of the temperature, and determining therefrom the temperature at which the maximum refining-relevant gas volume is released;
(2′) Measuring the released gas volumes of syntheses with pure sulfate refining under the same process conditions and the same glass composition and the same standard measuring procedure as was used for the reference-synthesis as a function of the temperature, respectively when adding different amounts of sulfates and respectively determining the temperature at which the maximum gas release occurs; and
(3′) Determining the temperature difference (increasing of temperature) for sulfate refining based on the values established in (1′) and (2′).

According to the present invention, determination of the temperature difference (increasing of the temperature) may occur in step (3) by:
preparation of a curve based on the maxima gas release from the gas release measurements according to step (2′) as a function of the respectively used sulfate amount (SO₃); and
reading the temperature maximum for the gas release based on the sulfate amount (SO₃) which is to be used in the refining agent, whereby the read temperature maximum compared to the reference provides the temperature differential which is to be set.

Based on a gas release curve as function of the temperature, the temperature can be determined whereby always the maximum of the gas release is available. By applying the maxima of gas release from the gas release measurements as a function of the amount of sulfate addition (amount of refining agent) in the batch for respective different sulfate amounts in pure sulfate refining, the increase in temperature during sulfate refining can be determined relative to the reference.

An additional advantage of the method of sulfate refining according to the present invention is that because of the change of the oxidation potential of the utilized sulfate refining agent in contrast to the previous antimony/sulfate refining, a displacement of the color tone results in the finished glass when refining with antimony oxide, which changes from a yellowish cast to a bluish color tone using the sulfate refining agent. The resulting glass with bluish color tone is highly transparent and seems more brilliant than the yellowish color tone utilizing the antimony oxide refining agent. During the drawing process the glass comes into contact only with air and is therefore “fire-polished” on both sides, transparent, lustrous and clear. According to the present invention the term “clear glass” therefore describes drawn glass produced according to the method of the present invention with a bluish color tone which is highly transparent. According to the present invention “highly” transparent means that a glass obtained from the drawing process according to the method of the present invention has a higher transmission than a glass with the same composition produced in the float process.

Moreover, by using the sulfate refining agent according to the method of the present invention, a very good quality is ensured with regard to freedom from bubbles. Therefore, refining can be achieved according to the inventive method whereby less than 5 bubbles/kg product are recognizably present in the obtained glass product, for example fewer than 3 bubbles/kg product or fewer than 1 bubble/kg product. This includes also the finest bubbles as long as they are recognizable with the eye.

According to the present invention, it is not expected that the antimony oxide refining agent can be completely replaced by a sulfate refining agent. Nonetheless, use of the method of the present invention results in the achievement of the desired refining and in addition is a highly transparent glass with blue color tone which is practically free of inclusions, bubbles etc., with high optical homogeneity or high spectral transmission. The solar glass production through the rolling method provides, for example, that antimony is added as an oxidation agent in order to provide a whiter appearance for the glass. It is, therefore, not obvious to the expert to consider a pure sulfate refining in the production of a drawn glass/clear glass.

In addition to using the sulfate refining agent, use of additional clarifying agents or reduction agents, for example the addition of transmission altering or color altering additives besides the actual glass components is not required. In order to ensure the maintenance of the high transmission, it is therefore possible to forgo chemical bleaching agents, for example Ni, Se and/or Co, and not to use halogen refining additives, such as chlorine containing or fluorine refining agents, to completely forgo coal since this can reduce existing irons and thereby alter the color effect, as well as to completely exclude transmission altering oxidation agents, i.e. cerium oxide. In addition, minimization of the iron content in raw material and in the production process is possible, since iron can come in two valences, whereby use of the refining agent can lead to oxidation of the iron and thereby to a change in the color effect into undesirable ranges. The glasses may therefore be produced according to the present invention, for example, free of added iron and contain iron at most only in the form of unavoidable contamination. Iron contents in the product between approximately 40 and 200 parts per million (ppm), for example between approximately 50 and 150 ppm are tolerable.

Only compounds are considered as additives for glass composition that do not negatively influence the properties of the glass that is to be produced. This is, for example TiO₂, for adjustment of the UV-edge.

Refining according to the method of the present invention for the production of clear glass described above can be implemented not only chemically, but also through purely physical refining. Here, refining is carried out through the utilization of negative pressure. The adjustment of negative pressure causes a union of the present bubbles, or respectively supports faster rising of bubbles. The negative pressure can be selected and adjusted by the expert according to the current state of the art based on some orienting tests.

Utilization of the physical refining, that is the negative pressure process in the method according to the present invention also provides a glass product having a bluish tint, which is intensively transparent and appears more brilliant than the glass with the yellow cast, which is produced by using an antimony oxide containing refining agent. The quality of the drawn glass is also very high, meaning that the finished glass product visibly contains fewer than 5 bubbles/kg product, for example fewer than 3 bubbles/kg product, or fewer than 1 bubble/kg product.

In the method according to the present invention, homogenization and the conditioning of the obtained glass melt follows after the refining area. This occurs, for example, through agitation. The glass then receives the desired shape in the subsequent drawing process. Regarding the drawing process according to the present invention, any drawing process known to the expert is suitable. Exemplary drawing processes are the so-called down-draw method and up-draw method. According to the down-draw method (“drawing downwards”) or the up-draw method (“drawing upwards”) a glass melt is drawn upward or respectively downward through a drawing tank with a drawing nozzle which has an aperture as a shaping component. The width of the drawing tank determines the respectively drawn ribbon of molten glass width. In the down-draw or up-draw method the applied drawing speeds are, for example, in the range of approximately 0.1 to 15 meters/minute (m/min), but can however in individual cases clearly exceed or fall below this range.

In the drawing process of the present invention, the down-draw method like overflow-fusion, redraw- and nozzle method are utilized. Up-draw methods used are, for example, Fourcault and Asahi methods as well as Libbey-Owens or Colburn methods and the Pittsburgh method. According to the present invention, however, the use of an up-draw method is an option.

Belgian engineer Emile Fourcault developed the first sheet glass drawing method, the so-called Fourcault method. The basic problem in direct drawing of glass from the melt is that the resulting ribbon of molten glass contracts due to surface tension until it transitions into a thin glass strand. This is prevented by the Fourcault method in that a fire resistant material is pushed into the molten glass with a center aperture, the so-called nozzle which tapers upward. Due to hydrostatic pressure, the glass streams out of the aperture and is drawn upward by means of a grapple which is located between rolls. Immediately above the drawing nozzle the so-called “onion” forms which serves to level the fictive glass melt, resulting in a ribbon of glass. The onion is evenly cooled by so-called cooling bottles. The edges, so-called borders of the glass streaming from the nozzle, are somewhat thicker and solidify faster than the center segment, thereby preventing contraction of the glass. The glass ribbon is pulled upward with the assistance of a drawing machine with numerous pairs of rolls while being cooled slowly. The vertical upward transport occurs in approximately 6 to 10 meter (m) high cooling stacks. The duration of cooling is established by the drawing speed and is therefore less for thin glass than for thicker glass. Located above the cooling stack is the cutting/breaking station where the rising glass ribbon is cut and broken.

One characteristic of drawn glass is that the nozzle leaves behind fine, almost invisible stripes which indicate the direction of drawing the glass. The thickness of the glass is established by the width of the nozzle aperture and change in the drawing speed: slow drawing results in thicker glass, faster drawing provides thinner glass. The drawing speed is limited by the viscosity of the glass at the onion. The higher the viscosity, the greater the drawing speed can be selected.

The Asahi-method which is a variation of the Fourcault method with altered nozzle block and drawing stack is another method which may be utilized according to the present invention in addition to the Fourcault method. In the Asahi method the nozzle block consists of mainly two rolls located parallel to each other or bars which are designed and arranged so that they form a slot which basically has the same function as a Fourcault nozzle.

An additional up-draw method which can be used is the Libbey-Owens or Colburn method which, in contrast to the Fourcault method, uses a nozzle-free drawing method to produce flat glass, whereby the drawn glass ribbon is rerouted from vertical to horizontal direction approximately 70 centimeters (cm) above the glass level.

Finally, according to the present invention, the Pittsburgh method can also be employed. This is also a vertical drawing method to produce flat glass, whereby, in contrast to the Fourcault method the glass ribbon is drawn from the open melt surface.

Glasses which can be produced according to the present invention are not especially limited. Any clear glass/drawn glass can be produced with it.

Since the solubility of SO₃ or respectively SO₂ in the molten glass, amongst other factors, also depends on the alkalinity of the utilized glass, glass having a relatively high alkalinity may be used. These are, for example, glasses having high alkaline and/or alkaline earth content. Contingent on the high alkaline and/or alkaline earth content these glasses are alkaline and therefore display high SO₂ solubility. The effectiveness of SO₃ as a refining agent based on the SO₂-solubility therefore increases the greater the alkalinity (alkaline and alkaline earth content) of the glasses. According to the present invention, glasses on the basis of so-called alkaline earth silicate glasses may be utilized according to the present invention. Zincous glasses may, for example, be utilized since these can only be produced on a limited basis with the float method, since zinc in the glass composition strongly evaporates under reducing conditions in the float bath and reacts with the tin in the tin float bath in an undesirable way.

According to the present invention, production of alkaline earth silicate glasses is possible. These include as main components SiO₂ as well as alkaline and alkaline earth oxides and possibly additional components.

The base glass normally contains, for example, at least approximately 55 weight % or at least approximately 65 weight % SiO₂. The maximum amount of SiO₂ is approximately 75 weight %. A range of around 65 to 75 weight %, for example 69 to 72 weight %, may be utilized.

Of the alkaline oxides, sodium and potassium in particular are of significance. According to the present invention the Na₂O content is in a range of approximately 0 to 15 weight %, for example approximately 6 to 13 weight %, or approximately 8 to 12.5 weight %. It may also be completely absent in the glass composition which is produced according to the present invention (Na₂O=0 weight %). The K₂O content according to the present invention is in a range of approximately 2 to 14 weight %, for example approximately 4 to 9 weight %. Li₂O is normally not present in the glass composition (Li₂O=0 weight %) of the present invention. Li₂O is expensive as a raw material. Therefore it is advantageous to dispense with it totally.

Exceeding or falling below the respectively cited alkaline oxide content has the disadvantage that the specification regarding the thermal expansion is no longer adhered to. Calcium, magnesium and barium in particular are utilized as alkaline earth oxides: CaO is utilized in a range of approximately 3 to 12 weight %, for example approximately 4 to 9 weight %, or approximately 4.9 to 8 weight %.

According to the present invention MgO is utilized in a range of approximately 0 to 4 weight %, for example approximately 0 to 3.6 weight %, or approximately 0 to 3 weight %. MgO can be used to improve the crystallization stability and to raise the transformation temperature (Tg). MgO can however, also be completely left out of the glass composition of the present invention (MgO=0 weight %).

BaO is used in a range of approximately 0 to 15 weight %, for example approximately 0 to 8 weight %, 0 to 3 weight %, approximately 0 to 2.5 weight %, or approximately 1.8 to 2.2 weight %. The addition of BaO can be drawn upon to increase the transformation temperature (Tg) of the glass composition. BaO can however be totally absent in the glass composition produced according to the present invention (BaO=0 weight %). The advantage of a low BaO content is a lower density and, therefore, a weight reduction in the produced glass, as well as cost savings of the expensive component BaO.

The glass composition of the present invention is substantially free of B₂O₃. This is advantageous because B₂O₃, on the one hand, is a concern toxicologically since—as is commonly known—the raw material is teratogen and, on the other hand, represents an expensive component which increases the cost of glass production significantly.

The amount of Al₂O₃ in the glass according to the present invention is in a range of approximately 0 to 15 weight %, for example approximately 0 to 8 weight %, or approximately 0 to 2 weight %. The content may be varied according to the specific application purpose. Exceeding the Al₂O₃ content of 15 weight % has the disadvantage of higher material costs and decreased melting capability. The content of Al₂O₃ can, however, also be 0 weight %.

According to the present invention, ZnO is present in an amount of approximately 0 to 5 weight %, for example approximately 0 to 4.5 weight %. Glasses containing ZnO can be produced with the drawing method according to the present invention, since they are practically inaccessible through the float method due to the discussed problems of the reaction of zinc and tin. The produced glass according to the present invention therefore contains, for example at least approximately 0.1 weight % zinc oxide. According to an additional embodiment of the present invention >2.0 weight % zinc oxide can be contained in the glass produced.

Moreover, the glass composition of the present invention can contain TiO₂ in an amount of approximately 0 to 2 weight %, for example approximately 0 to 1.5 weight %. TiO₂ can be applied in the usual manner to block UV in the glass.

The produced glass can contain Zr in the analysis, contingent on corrosion of the Zr-containing tank block materials. Other than that substantially no Zr is actively added through raw materials (ZrO₂=0 weight %) and therefore may be present as normal contamination.

Not present in the inventive glass composition are:

As₂O₃, Sb₂O₃, SnO₂ halogenated refining agents, chemical bleaching agents such as Ni, Se and/or Co, coal as well as transmission altering oxidants (i.e. cerium oxide), and also no reducing agents. In addition, the iron content may be reduced to a minimum in order to avoid undesirable discoloration of the produced glass. An active addition of iron is therefore not provided. Moreover, it is possible to take measurements for the minimization of iron contaminations through raw materials and in the process. The method of the present invention may be carried out so that contamination through raw materials, and in the process are minimized.

According to the present invention, Alkaline-, alkaline earth- and/or zinc sulfate are used as a refining agent. Sodium, potassium, barium, calcium or zinc sulfate are exemplary refining agents.

An exemplary glass composition that can be produced with the method of the present invention includes the following glass composition (in weight % on oxide basis):

| | |
|---|---|
| SiO₂ | approximately 55-75 weight % |
| Na₂O | approximately 0-15. weight % |
| K₂O | approximately 2-14 weight % |
| Al₂O₃ | approximately 0-15 weight % |
| MgO | approximately 0-4 weight % |
| CaO (Sum) | approximately 3-12 weight % |
| BaO | approximately 0-15 weight % |
| ZnO | approximately 0-5 weight % |
| TiO₂ | approximately 0-2 weight % |
| CaO (CaSO₄) | approximately 0.5-1.5 weight %. |

An additional embodiment of the glass composition of the present invention (in weight % on oxide basis) is:

| | |
|---|---|
| SiO₂ | approximately 65-75 weight % |
| Na₂O | approximately 8-13 weight % |
| K₂O | approximately 4-9 weight % |
| Al₂O₃ | approximately 0-2 weight % |
| MgO | approximately 0-4 weight % |
| CaO (Sum) | approximately 4-9 weight % |
| BaO | approximately 0-3 weight % |
| ZnO | approximately 0-5 weight % |
| TiO₂ | approximately 0-2 weight % |
| CaO (CaSO₄) | approximately 0.5-1.5 weight %. |

A third embodiment of the glass composition of the present invention includes (in weight % on oxide basis:

| | |
|---|---|
| SiO₂ | approximately 65-75 weight % |
| Na₂O | approximately 8-10 weight % |
| K₂O | approximately 6-9 weight % |
| CaO (Sum) | approximately 4-9 weight % |
| BaO | approximately 1-3 weight % |
| ZnO | approximately 3-5 weight % |
| TiO₂ | approximately 0-2 weight % |
| CaO (CaSO₄) | approximately 0.5-1.5 weight % |

The advantages which can be achieved with the method of the present invention are very complex. Through the method of the present invention, heavy metal refining agents, such as antimony oxide, or other refining agents which are health hazards such as arsenic oxide, or particularly expensive refining agents, such as CeO₂ can be avoided and can be replaced by a sulfate refining agent which is not a health hazard and is cost effective. Pure sulfate refining therefore offers the advantage according to the present invention of avoiding heavy metals of all types and at the same time providing a surprisingly high quality drawn glass with accordingly few or no bubbles.

The sulfate refining agent is completely harmless toxicologically, so that practically no restrictions regarding its application in the produced glasses result. The refined products according to the present invention are environmentally friendly due to the use of the non-toxic refining agent. The sulfate refining of the present invention is implemented at a refining temperature in the range of approximately 1480° C. to 1570° C., for example approximately 1500° C. to 1530° C., in other words a refining temperature which is approximately 30° C. to 60° C. higher than in a conventional refining method utilizing an antimony oxide-containing refining agent or in antimony oxide/sulfate refining. The energy supply in the production method of the present invention is raised, for example, only during the refining process. The energy distribution in the melting tank can be modified to support the refining effect. This is accomplished, for example, in that the melting tank geometry is designed accordingly.

The addition of sulfate, in a defined amount according to the explained method, through determination of the released gas volume at various amounts of sulfate refining agents compared to a reference causes very effective refining which manifests itself in excellent glass quality, that is lack of bubbles and seeds in the produced glass. Very effective degassing/bubble removal could be observed in the glass melts due to the method of refining according to the present invention. The obtained glass product visibly contains fewer than 5 bubbles/kg product, for example fewer than 3 bubbles/kg product, or fewer than 1 bubble/kg product.

An additional advantage of the sulfate refining of the present invention is that instead of a yellow cast glass—as results in refining with antimony oxide—a clear glass having a blue color cast is obtained which is highly transparent with high optical homogeneity and high spectral transmission and, due the bluish color cast, appears more brilliant than the glass having the yellowish color. This is due to the fact that the method of the present invention provides a clear glass with a transmission which is greater than in a comparable float glass.

The addition of sulfate refining agents, calculated as SO₃ occurs for example in a range of approximately 0.2-1.5 weight % or in a range of 0.7-1.2 weight %.

The use of transmission altering or color altering additives in addition to the actual glass components, for example of additional refining agents or reduction agents, is not required according to the present invention.

The inventively applied drawing method is not particularly limited within the scope of the present invention. Any drawing process known to the expert can be used. Used, for example, are so-called down-draw and up-draw methods, whereby the so-called up-draw method is, for example the Fourcault method.

The method of the present invention provides efficient and cost effective refining of, for example alkaline glasses, or alkaline earth silicate glasses.

For the expert it is unexpected that the method of producing clear glass in a drawing method according to the present invention, in contrast to production of soda-lime glass using sulfate refining without addition of reduction agents, is possible, whereby surprisingly good results are achieved. According to the present invention this can be achieved by determining the described process parameters, the increase in the refining temperature, the defined adjustment of the amount of sulfate-refining agent and, if applicable, adaptation of the melting tank geometry in order to achieve an optimum energy distribution in the tank.

Instead of the described chemical refining, physical refining by use of low pressure can also be utilized.

There are a number of parameters which the expert can vary within the scope of the method of the present invention, for example the type of the sulfate refining agent used, the energy distribution in the melting tank, the melting tank geometry, the type of the glass which is to be produced, style and adjustment of the burners, the style and operation of the batch insertion technology, etc. Additional variations and modification possibilities in the current state of the art are obvious to the expert.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a simplified schematic illustration of an exemplary embodiment of the method of the present invention;

FIG. 2 shows 3 example glasses, characterized based on the lab-color system;

FIG. 3 shows 3 curves, obtained from the measurement of gas release of CO₂, SO₂ and O₂ of a reference synthesis with an antimony and sulfate-containing refining agent according to the present invention, whereby the gas flow is stated as a function of the temperature;

FIGS. 4-7 each show the curves obtained from the measurement of the gas release of CO₂, SO₂ and O₂ of synthesis with varying amounts of antimony-free, sulfate-containing refining agent according to the present invention, whereby the gas flow is stated as a function of the temperature;

FIG. 8 shows 2 curves obtained from the measurements of the gas release for the total released gas flow (SO₂+O₂) as a function of the used sulfate amount (SO₃) for examples 5 and 6 with varying sulfate refining agent content, the value obtained for the reference synthesis and the curve which is expected according to the present invention;

FIG. 9 shows the temperatures of the maximum gas release (SO₂) as determined by the gas release curves in FIGS. 4 through 7 as a function of the amount of sulfate refining agent according to the present invention, stated as SO₃ in weight-%.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

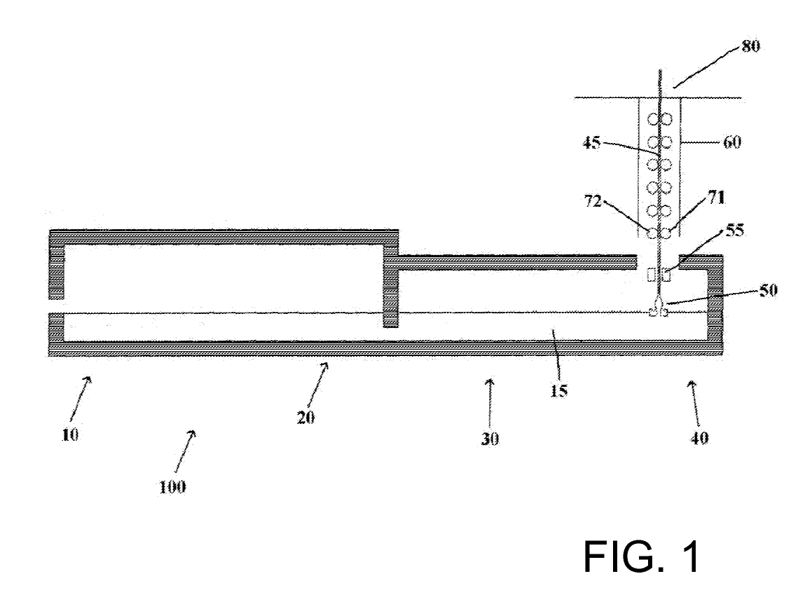

Referring now to the drawings, and more particularly to FIG. 1, there is shown a simplified schematic illustration of an embodiment of the production of clear glass according to the present invention. Initially a batch is produced, then placed in a melting tank where it is melted. This occurs, for example, in melting tank 100 which is illustrated schematically simplified. Melting occurs, for example, with assistance of various burners (not illustrated), for example gas burners, at temperatures of approximately 1470° C. The batch melt in the embodiment of molten glass 15 is then brought from melting area 10 to refining area 20 where refining takes place. The refining agent of the present invention is a sulfate refiner whereby temperatures in the range of approximately 1480° C. to 1570° C., for example approximately 1500° C. to 1530° C., are used. This is followed by homogenizing of liquid gas 15 in area 30.

In the illustrated, work segment 40 of continuous tank 100 a Fourcault method is illustrated as exemplary drawing process for the clear glass produced according to the present invention. For this purpose drawing nozzle 50, for example of fire clay, is provided which is pressed into molten glass 15 and is anchored there. The glass streams from the aperture of nozzle 50. A grapple not (shown) is guided from above to the gushing glass; the glass adheres to the grapple and is pulled with the strip vertically upwards—in the illustrated example an approximately 6 to 8 m high drawing stack 60. Ribbon of molten glass 45 in an appropriate width is created. Cooler 55 near the glass surface lowers the glass temperature in such a way that the glass becomes dimensionally stable. Roll pairs 71, 72 located in drawing stack 60 carry the molten glass ribbon 45 which is being cooled at the same time. Located at the end of drawing stack 60 is cutting/breaking station 80 where the glass ribbon is appropriately trimmed.

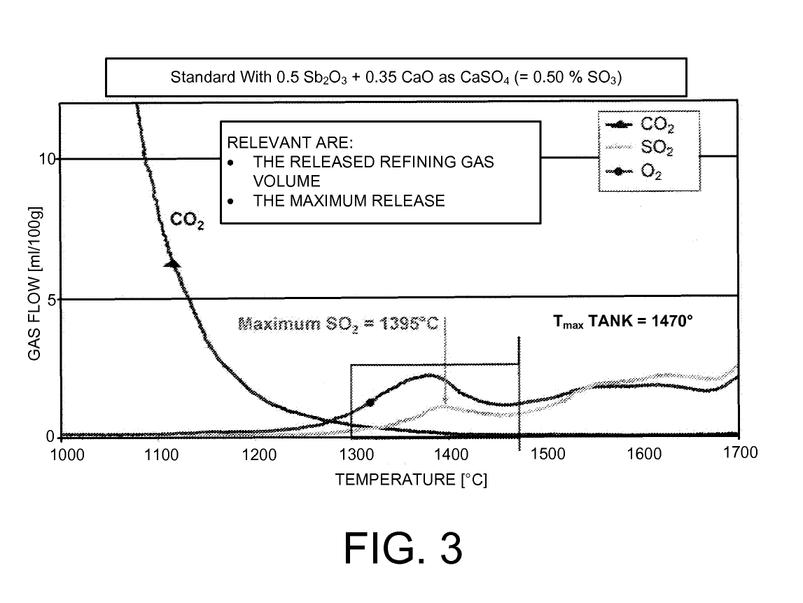

Referring now to FIGS. 3-9, which illustrate how the sulfate refining agent amount and the necessary temperature increase during refining can be determined according to the invention. determination of the amount of the sulfate refining agent according to the present invention includes the following steps:
(1) Initially the volume of released gas (gas flow for SO₂, O₂ and CO₂) are measured for a reference synthesis and the values are plotted as a function of the temperature. For the reference synthesis the process conditions and the glass composition are selected accordingly, whereby the refining agent contains antimony and sulfate and the method therefore is actually conducted in accordance with the current state of the art. Based on the measured gas release, the calculation of the released total volume of gas in the relevant temperature range (before start of refining until maximum reached temperature—for example approximately 1250° C. to 1470° C.) can then occur for the reference synthesis.

In the example shown in FIG. 3, the curves for SO₂, CO₂ and O₂ (gas flow as function of the temperature) are illustrated which were obtained in measurements of the released gas volume in a reference synthesis with a refining agent, whereby the refining agent had a composition of approximately 0.5 weight-% Sb₂O₃ and approximately 0.35 weight-% CaO as CaSO₄, which computes to approximately 0.50 weigh-% SO₃. FIG. 3 therefore illustrates the reference curve.
(2) Then the measurement of the released gas volume is undertaken with different amounts of sulfate refining agents (antimony free refiner which contains only sulfate as refining-effective component) under the same process conditions and with the same glass composition as for the reference synthesis according to FIG. 3. With the measured gas release, the calculation of the released total gas volume can again be determined in the analog temperature range like in the reference (before start of refining until maximum reached temperature—for example approximately 1250° C. to 1470° C.).

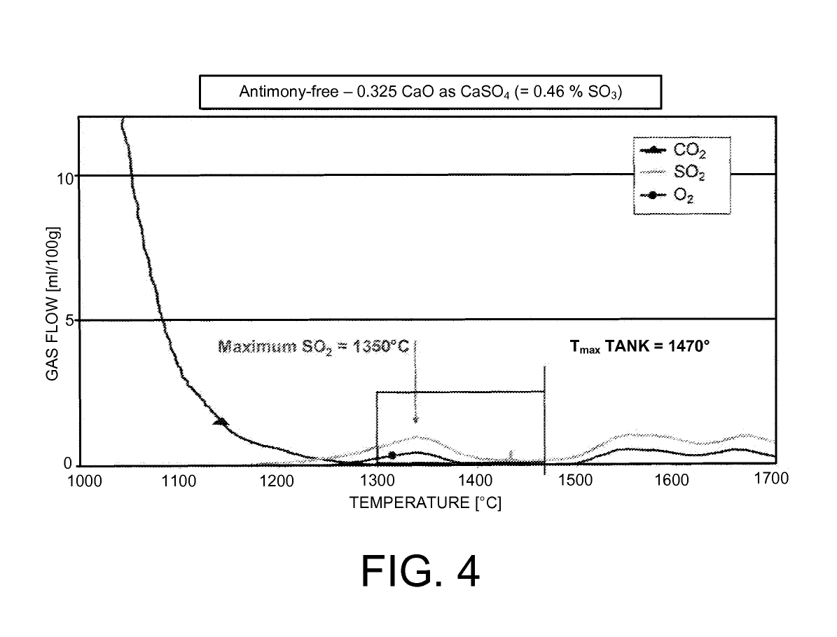

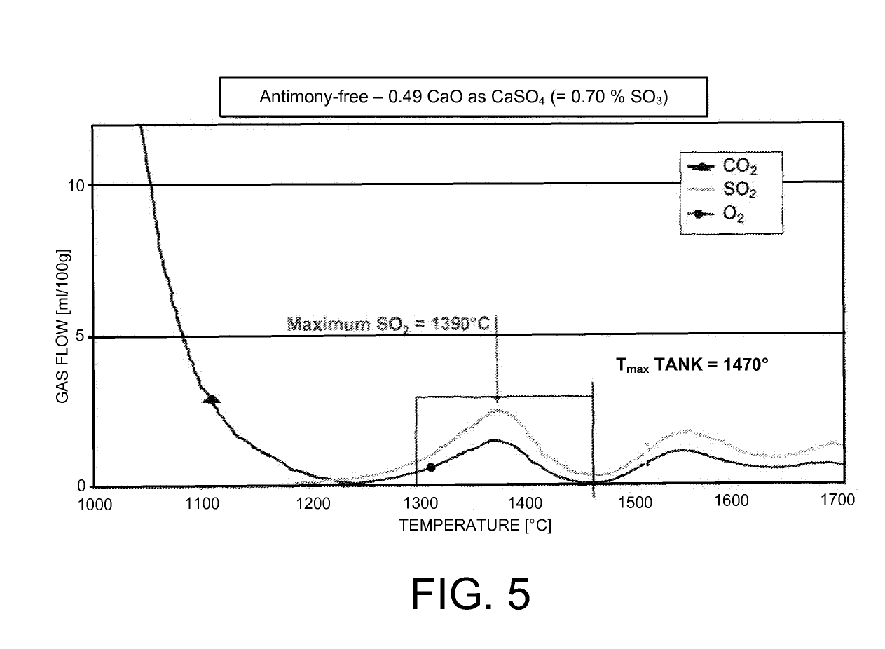

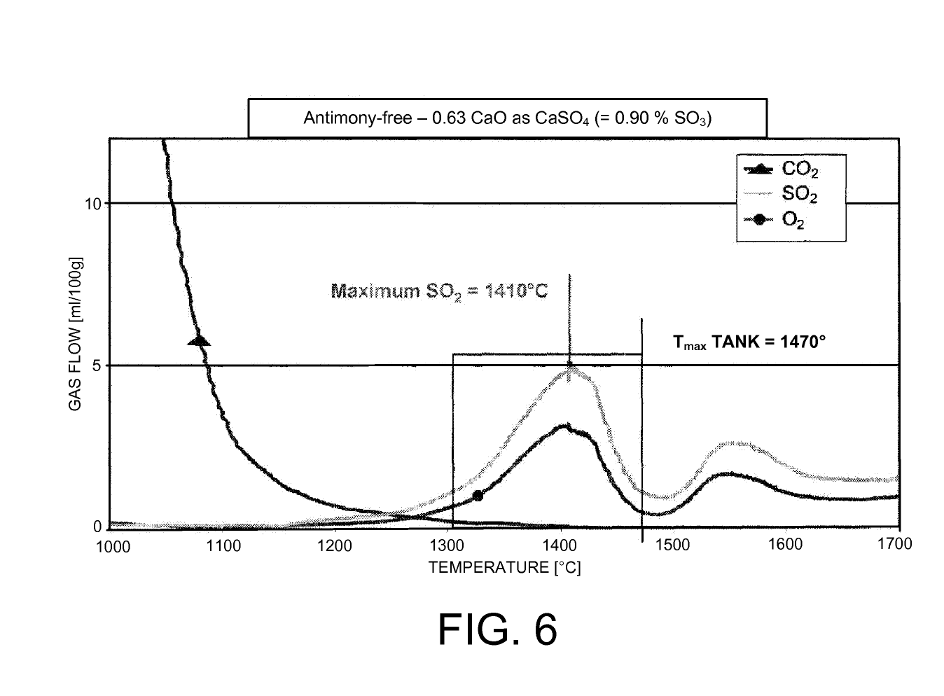

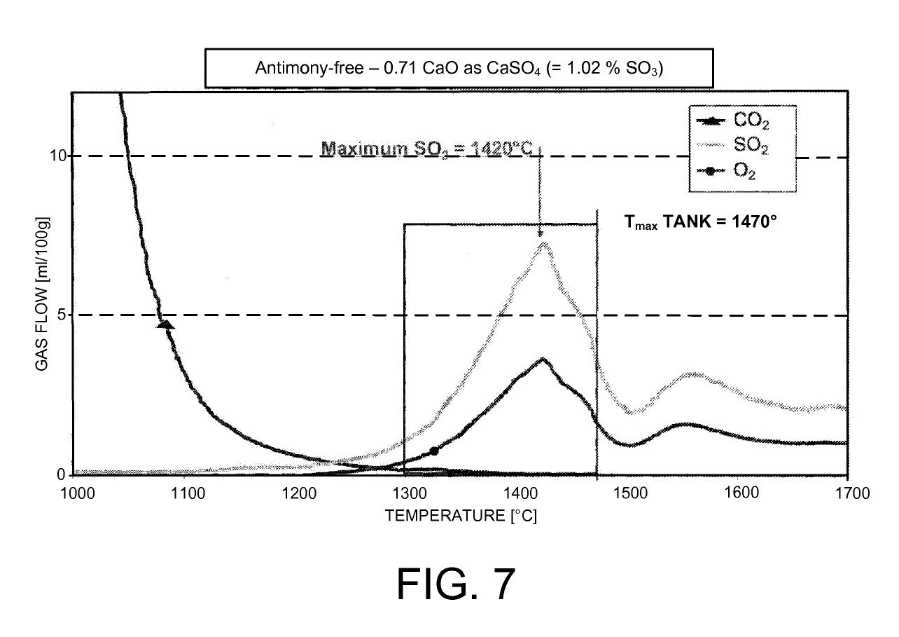

FIGS. 4 through 7 illustrate 3 exemplary curves for CO₂, SO₂ and O₂, whereby the gas flow (the gas release) is stated as a function of the temperature. Antimony-free refining agents with varying sulfate contents were used. In FIG. 4, the refining agent, including approximately 0.325 weight % CaO as CaSO₄, which when converted is consistent with approximately 0.46 weight % SO₃, was used. In FIG. 5, the refining agent, including approximately 0.49 weight % CaSO₄, which when converted is consistent with 0.70 weight % SO₃, was used. In FIG. 6, the refining agent, including approximately 0.63 weight % CaSO₄, which when converted is consistent with approximately 0.90 weight % SO₃, was used. In FIG. 7, the refining agent, including approximately 0.71 weight % CaSO₄, which when converted, is consistent with approximately 1.02 weight % SO₃, was used.

From FIGS. 4 through 7, it can therefore be determined that with increasing amounts of sulfate refining agent, the released gas volume (SO₂+O₂) increases. In this context, it must be pointed out that the sulfate in the sulfate refining agent is calculated as SO₃ in order to be able to provide uniform data for all sulfates, however the released gas from the sulfate refining agent represents SO₂+O_{2.}

During the determination, the later addition of shards in the glass batch may also be considered, since sulfate, in contrast to, for example antimony, in the shards no longer effectively refines as long as the melting temperature is not raised above the maximum point through which the shards have passed during the prior melting process.
(3) Based on a comparison of the total gas release in the standard synthesis (antimony/sulfate refining agent) according to FIG. 3 with the total gas release in a process with pure sulfate refining, the sulfate refining agent amount—in order to achieve an analog released gas volume in the analog temperature range as for the reference synthesis—can be determined.

In this context, it is significant that for each glass composition another curve results for the measured gas release. One cannot make a determination from one glass composition to another glass composition. On the contrary, steps (1) to (3) as described above must be followed for each glass composition. This means, first a reference synthesis must be selected, the gas release must be measured and the total released gas volume must be calculated. Then, the measurements for pure sulfate refining must be conducted for this glass composition in order to also calculate the total released gas volume for sulfate refining. The comparison of both tests (reference and sulfate refining) then leads to the determination of the sulfate refining agent amount which is used according to the present invention.

Referring now to FIG. 6, there is shown a comparison between a reference synthesis and pure sulfate refining, whereby the total released gas volume (gas flow SO₂+O₂) is stated as function of the sulfate addition (sulfate refining agent) in the batch. In the current example the reference synthesis contains a refining agent, composed of approximately 0.5 weight % Sb₂O₃ and approximately 0.5 weight % SO₃.

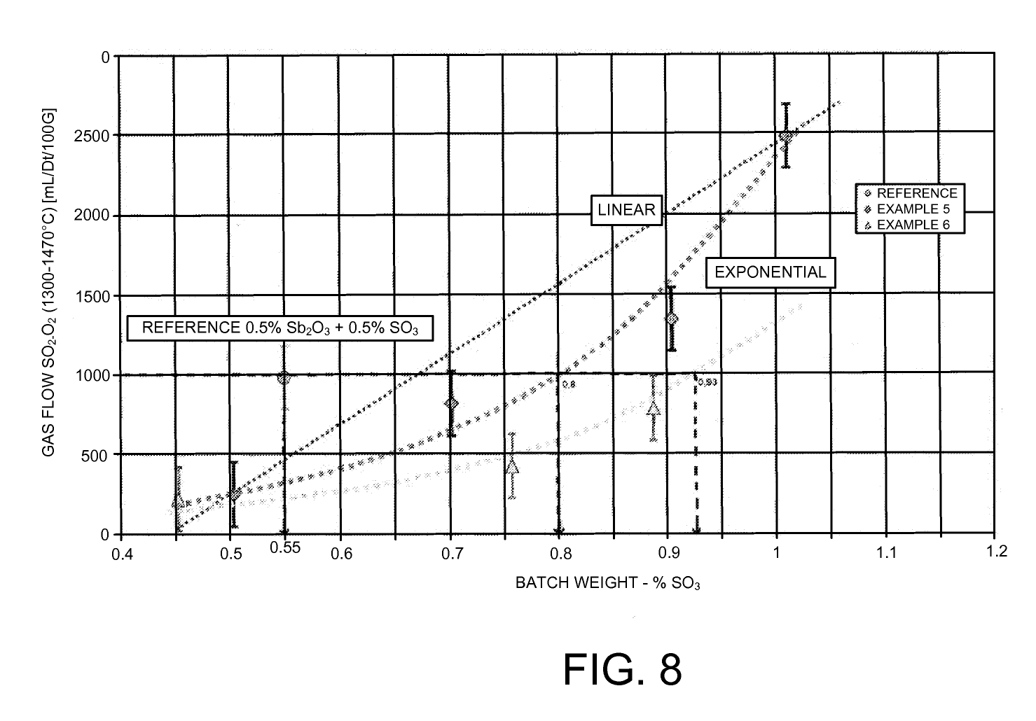

The straight line (“linear”) shown in FIG. 8 provides the theoretical linear formulation which clearly deviates from the curves measured in reality (“exponential” curve). The measured values and the curves resulting therefrom are illustrated for example 5 (rhombi) and example 6 (deltas). For the purpose of the reference, it can be determined from FIG. 8 that, for a gas flow of approximately 1000 mL/dT/100 g, read on y-axis, an amount of approximately 0.55 weight % SO₃ must be used (read on the x-axis for the reference). This is also shown in FIG. 8. If the same gas flow as in the reference for example 5 is to be selected, one follows from the top of the reference parallel to x-axis toward the right until the curve of example 5 is intersected and can thereby read the SO₃ amount of approximately 0.8 weight %. This is also illustrated in FIG. 8. For example 6 therefore, a portion of approximately 0.93 weight % results. From this, one can easily calculate the sulfate amount which is used in form of the sulfate refining agent. Since in example 6 shards were added to the starting material, a sulfate amount of approximately 1 weight % results under consideration of the shard portion which is to be used in order to achieve the desired refining.

When comparing a standard synthesis (with antimony and sulfate refining) and a synthesis with pure sulfate refining, the sulfate refining agent amount is immediately obtained.

The determination of the temperature for the sulfate refining according to the present invention is discussed below:

The result from FIGS. 4 through 7 is not only that with an increasing amount of sulfate refining agent, the released gas volume increases, but also that the temperature at which the greatest SO₂ volume is released is moved to higher temperatures (that is toward the right on the x-axis): In FIG. 4 the maximum for SO₂ release is at a temperature of approximately 1350° C., in FIG. 5 at approximately 1390° C., in FIG. 6 at approximately 1410° C. and in FIG. 7 at approximately 1420° C.

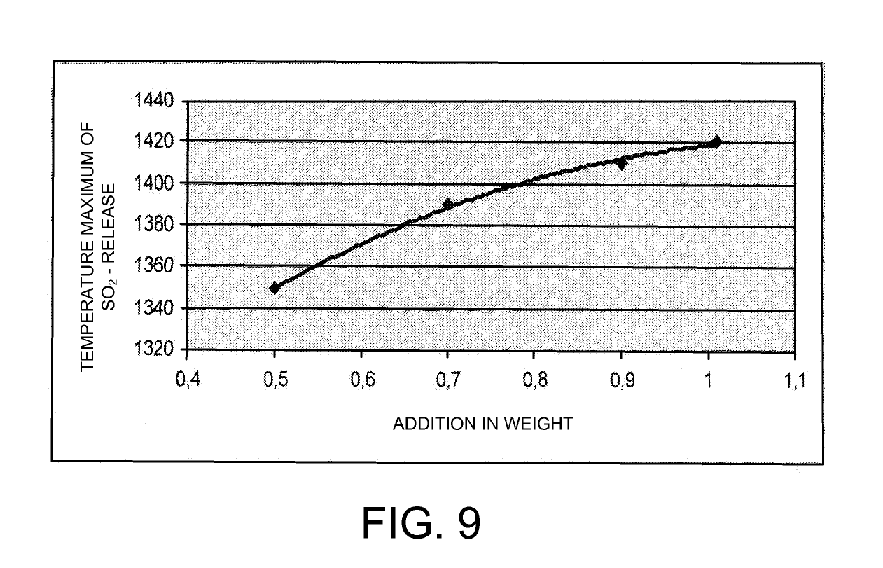

By applying the gas release curves as a function of the temperature (illustrated, i.e. in FIGS. 4 through 7), the temperatures can be determined at which maximum gas release occur. By applying the maxima of gas release from the gas release measurements as a function of the sulfate addition amount (amount of sulfate refining agent) in the batch, the increase in temperature in refining can be concluded. In other words, the displacement of the maxima between reference and pure sulfate refining with a selected sulfite amount provides data regarding the temperature displacement of the maximum temperature in the tank. Referring now to FIG. 9, there is shown an exemplary depiction of this. FIG. 9 illustrates the respective temperature maxima for the maximum SO₂ release as a function of the SO₃ addition amount in weight % which are taken from FIGS. 4 to 7. For the maximum gas release for the reference the temperature maximum was determined at approximately 1395° C. (also see FIG. 3). At approximately 1 weight % SO₃ in the batch, the maximum of the release according to FIG. 9 is at approximately 1420° C. This provides a preferred default for the increase in the maximum temperature in the tank around the temperature difference (the delta), that is 25° C. compared to the reference.

By comparing a standard synthesis and a pure sulfate refining, the temperature for pure sulfate refining according to the present invention can be determined.

FIGS. 1 through 9 clarify only exemplary embodiments of the method of the present invention. These are to be understood not to be limiting. The present invention is explained below with reference to examples which pictorialize the science of the present invention, but are however not intended to restrict it:

Glass compositions were selected and glasses produced according to the inventive method of the present invention. The method of the present invention includes the steps of melting, refining, homogenizing and utilization of the Fourcault process. Refining was carried out at a temperature in the range of approximately 1500° C. to approximately 1530° C. CaSO₄, or respectively a combination of Sb and CaSO₄, was used as the refining agent. In the following table 1 the compositions (analyses) of the selected glass compositions are summarized. Differences in the summation result from measuring inaccuracies in the analytical measuring process.

TABLE 1

| [in weight | | | | | | | |
|---|---|---|---|---|---|---|---|
| %] | Example 1 | Example 2 | Example 3 | Example 4 | Example 5 | Example 6 | Example 7 |
| SiO₂ | 71.85 | 69.67 | 68.85 | 70.30 | 68.85 | 70.30 | 68.85 |
| Na₂O | 12.40 | 9.41 | 8.03 | 10.75 | 8.03 | 10.75 | 8.03 |
| K₂O | 4.55 | 6.59 | 8.30 | 4.65 | 8.30 | 4.65 | 8.30 |
| Al₂O₃ | 1.50 | — | — | — | — | — | — |
| MgO | 3.60 | — | — | — | — | — | — |
| CaO | 5.70 | 7.57 | 7.20 | 8.74 | 7.20 | 8.74 | 7.20 |
| (Sum | | | | | | | |
| total*) | | | | | | | |
| BaO | — | 1.87 | 2.09 | 1.65 | 2.09 | 1.65 | 2.09 |
| ZnO | — | 3.60 | 4.42 | 2.76 | 4.43 | 2.76 | 4.43 |
| TiO₂ | — | 0.60 | 0.32 | 0.26 | 0.32 | 0.26 | 0.32 |
| Sb₂O₃ | — | — | 0.49 | 0.54 | — | — | — |
| CaO | 0.45 | 0.84 | 0.35 | 0.40 | 0.70 | 0.85 | 0.70 |
| (CaSO₄) | | | | | | | |
| SO₃ | 0.26 | 0.48 | 0.20 | 0.23 | 0.40 | 0.49 | 0.40 |
| Fe₂O₃ | 0.0220 | 0.0090 | 0.0180 | 0.0170 | 0.0100 | 0.0095 | 0.0180 |
| Sum total | 99.88 | 99.80 | 99.92 | 99.90 | 99.63 | 99.60 | 99.64 |
| Tₘₐₓ tank | 1540 | 1520 | 1460 | 1470 | 1510 | 1510 | — |
| ° C. | | | | | | | |
| Burner | 35/40/25 | 22/36/22/ | 20/36/22/ | 22/36/22/ | 22/36/22/ | 22/36/22/ | — |
| distribution | | 20 | 22 | 22 | 20 | 20 | |
| Total | 270 | 440 | 390 | 410 | 440 | 440 | — |
| energy | | | | | | | |
| m³ gas/h | | | | | | | |
| Throughput | 18 | 19 | 22 | 22 | 19 | 19 | — |
| t/d | | | | | | | |
| Bubbles/ | 3 | <1 | <1 | <1 | <1 | <1 | — |
| kg | | | | | | | |

Of note, all CaO, that is CaO (glass components) + CaO which results from CaSO₄ (refining agent).

Tank adjustments according to the present invention are cited below for examples 1 and 5:

a) Tank setting for example 1: The utilized tank has the following specifications:

3 port gas-fired regenerative tank with electric smelting assistance;
1×b×h=7.5 m×3.3 m×0.5 m, whereby 1 represents length, b represents width and h represents height

The throughput amounted to 1-2 t/m³ a day, or 0.5-1 t/m² a day.

The usual tank adjustments (state of the art) are as follows:

| | |
|---|---|
| Melting temperature | 1460-1480° C. |
| Melting tank energy distribution | 18-22/36/22/20-24% |
| Bubbling gas volume | 20-25 l/h |
| Bubbling gas | Oxygen |

The following table 2 shows exemplary tank adjustments with which the glass compositions according to example 1 from table 1 were produced according to the present invention. The adjustments given as reference are consistent with the state of the art. The adjustments consider that for a pure sulfate refining a higher melting temperature was set and the energy distribution in the tank was accordingly modified.

TABLE 2

| | | | Example 1 | |
|---|---|---|---|---|
| | | | According to the | |
| | Reference settings | | present invention | |
| Melting temperature | 1375/1470/1430° C. | | 1430/1540/1480° C. | |
| SW-energy distribution | 27/40/33% | | 35/40/25% | |
| Melting electrodes | 500 | A | 500 | A |
| Bubbling gas volume | 20 | l/h | 27-30 | l/h |
| Energy consumption | 230 | m³/h | 270 | m³/h |
| Shard content | 50% | | 40% | |
| Throughput | 18 | t/d | 18 | t/d |

b) Tank settings for example 5: The utilized tank has the following specifications:

4 port gas-fired regenerative tank with electric smelting assistance;
1×b×h=10 m×3.5 m×1 m and the throughput amounted to 0.5 to 1 t/m³ a day, or 0.5-1 t/m² a day.

The following table 3 shows exemplary tank settings with which the glass composition according to example 5 from table 1 was produced. The settings given as reference are consistent with those used in the state of the art. The settings consider that a higher melting temperature was set and the energy consumption in the tank was accordingly modified in accordance with the present invention.

TABLE 3

| | | Example 5 |
|---|---|---|
| | Reference settings | Inventively preferred settings |
| Melting temperature | 1400/1460/1450° C. | 1465/1520/1505° C. |
| SW-energy distribution | 20/30/22/22 | 22/36/22/20 |
| Bubbling gas volume | 20-23 l/h | 20-23 l/h |
| Energy consumption | Natural gas 396 m³/h | 440 m³/h |
| Shard content | 45% | 30% |
| Throughput | 22 t/d | 19 t/d |

With the stated tank settings according to the present invention, clear glasses can be produced with especially good refining results.

L-a-b-color system: In order to characterize the clear glasses produced by means of the L-a-b-color system, the glasses from examples 3, 5 and 7 were selected and characterized. The L-a-b-color system is a system which was developed to capture the color effect which is received by the eye by means of a scale and to definitively present the colors independent from the type of the production and reproduction technology. Each discernible color is defined in the color space by the color location with the coordinates {L, a, b}. In the following table 4, the measured values are stated as having been obtained with standard illumination D65 at a test length of 20 mm for the selected examples.

TABLE 4

| | Example 3 | Example 5 | Example 7 |
|---|---|---|---|
| L | 95.9 | 95.9 | 96.2 |
| a | −0.92 | −0.95 | −0.62 |
| b | 1.5 | 0.84 | 0.68 |

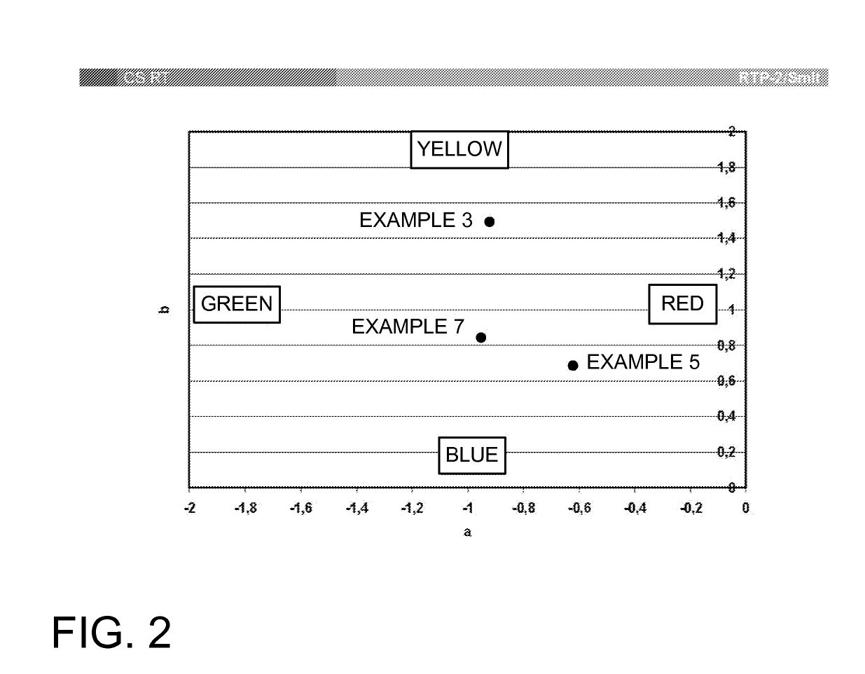

Referring now to FIG. 2 there are shown the obtained measured values for examples 3, 5 and 7. All tested glass samples had a length of 20 mm and were measured with standard illumination D65. The comparative glass with antimony/sulfate mixture refining (example 3) shows a clearly yellow-green color cast. By changing over to pure sulfate refining according to the present invention, the color cast moves—with the same composition and analog iron contents—toward blue (example 7). The reduction in iron contents in the glass (example 5) leads to a small change of the color impression in the direction of red-blue.

Color location comparison: As already explained for the L-a-b-color system, the color location within the color space is provided exactly by three coordinates. Through a color location comparison of one float glass with a clear glass produced according to the present invention, the following values were measured:

TABLE 5

| | Float glass | Inventive clear glass |
|---|---|---|
| Thickness | 5.85 mm | 5.97 mm |
| L | 95.8 | 96.7 |
| A | −1.53 | −0.17 |
| B | 0.16 | 0.27 |

Referred to standard illumination D65, 2°-observer
The clear glass according to the present invention therefore has a transmission L which is almost 1% greater and a clearly lesser green color effect than standard float glass. A standard float glass is therefore less transparent than the inventive clear glass, whose color effect moreover appears more brilliant and lighter.

The produced glass compositions according to the present invention displayed an excellent quality, even though the conventionally used antimony oxide refining agent was completely left out. The obtained clear glasses had a high transparency and brilliant appearance at light bluish coloring. The clear drawn glasses showed practically freedom from bubbles with fewer than 5 bubbles/kg, for example than 3 bubbles/kg, or fewer than 1 bubble/kg of produced glass, and a high optical homogeneity at high spectral transmission.

Therefore, an inventive method to produce a clear glass according to the present invention or clear drawn glass is provided for the first time which can be implemented without the use of a heavy metal refining agent, especially antimony oxide refining agent, and which nonetheless provides the desired high quality in the produced clear glass.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.
10 Melting area
15 liquid gas
20 refining area
30 homogenizing area
40 work segment
45 glass ribbon
50 drawing nozzle
55 cooler
60 drawing shaft
71, 72 pair of rolls
80 cutting/breaking station
100 continuous tank

What is claimed is:

1. A method of producing one of a clear glass and a clear drawn glass, the method comprising the steps of:
melting starting materials to obtain a glass batch melt;
selecting a sulfate refining agent from at least one of an alkaline sulfate, an alkaline earth sulfate, and a zinc sulfate;
refining said glass batch melt with a predetermined amount of said sulfate refining agent at a predefined refining temperature, said predefined refining temperature being in a range of between approximately 0° C. to 100° C. higher than a second refining temperature defined in a refining process using one of an antimony oxide refining agent and said antimony oxide combined with at least one other refining agent;
homogenizing said glass batch melt; and
producing a glass product from said batch melt in a drawing process.

2. The method according to claim 1, wherein said predefined refining temperature is between approximately 30° C. to 60° C. than said second refining temperature.

3. The method according to claim 1, wherein said one of said alkaline sulfate and said alkaline earth sulfate is one of sodium sulfate, potassium sulfate, calcium sulfate and barium sulfate.

4. The method of claim 3, wherein said predetermined amount of said sulfate refining agent is established by the steps of:
measuring a first released gas volume of a reference synthesis as a function of temperature according to a standard measuring procedure using a reference refining agent including antimony and sulfate and determining a first total released gas volume;
measuring a set of second released gas volumes of a plurality of syntheses as a function of temperature using pure sulfate refining under said standard measuring procedure under a set of process conditions and with a glass composition which are the same as used in said reference synthesis, respectively adding a plurality of different amounts of sulfate to determine a second total released gas volume; and
determining said predetermined amount of said sulfate refining agent based on said first total released gas volume and said set of second released gas volumes.

5. The method according to claim 4, wherein said step of determining said predetermined amount of said sulfate agent further comprises the steps of:
generating a curve based on said set of second released gas volumes as a function of said amount of sulfate used;
furnishing said first total released gas as a function of a first amount of sulfate used in said reference synthesis; and
reading an amount of sulfate to be used which is present in a same total released gas volume as said reference synthesis.

6. The method according to claim 3, wherein said predefined refining temperature is determined by the steps of:
measuring a first released gas volume for a reference synthesis as a function of temperature according to a standard measuring procedure using a reference refining agent including antimony and sulfate and determining a reference temperature at which a reference maximum gas volume is released;
measuring a set of second released gas volumes for a plurality of syntheses with different amounts of a pure sulfate refining agent as a function of temperature according to said standard measuring procedure and under process conditions and a glass composition which are the same as used in said reference synthesis and determining a second temperature at which a maximum of said set of said second released gas volumes occurs; and
determining a temperature difference for sulfate refining based on said first released gas volume and said second temperature at which said second maximum gas release occurs.

7. The method according to claim 6, wherein said determining said temperature difference step further comprises the steps of:
preparing a curve based on said set of second released gas volumes as a function of an amount of said sulfate used for each of said plurality of syntheses; and
reading a temperature maximum for gasses released based on said sulfate amount which is to be used in said sulfate refining agent, said read temperature compared to said reference temperature providing said temperature difference to be set.

8. The method according to claim 1, wherein said drawing process is one of a down-draw method and an up-draw method.

9. The method according to claim 8, wherein said drawing process is said up-draw method.

10. The method according to claim 9, wherein said drawing method is one of a Fourcault method and an Asahi method.

11. The method according to claim 10, wherein said drawing method is said Fourcalt method.

12. The method according to claim 1, wherein said sulfate refining agent, calculated as sulfate, is in a range of between approximately 0.2-1.5 weight %.

13. The method according to claim 12, wherein said sulfate refining agent is in a range of between approximately 0.7-1.2 weight %.

14. The method according to claim 1, wherein said predefined refining temperature is in a range between approximately 1480° C. and 1570° C.

15. The method according to claim 14, wherein said predefined refining temperature is in a range between approximately 1500° C. and 1530° C.

16. The method according to claim 1, wherein no additional refining agent is used.

17. The method according to claim 16, wherein no chemical bleaching agents, no coal, no transmission-altering oxidants, no iron and no reduction agents are used.

18. The method according to claim 1, wherein said melting step and said refining step are implemented in a melting tank and energy is supplied to said melting tank increasing from a front section of said melting tank where said glass batch melt is melted to a rear section of said melting tank where said refining takes place.

19. The method according to claim 18, wherein said glass product produced is an alkaline earth silicate glass having a composition in weight % on an oxide basis of:

| | | |
|---|---|---|
| SiO₂ | 55-75 | weight %; |
| Na₂O | 0-15. | Weight %; |
| K₂O | 2-14 | weight %; |
| Al₂O₃ | 0-15 | weight %; |
| MgO | 0-4 | weight %; |
| CaO (Sum) | 3-12 | weight %; |
| BaO | 0-15 | weight %; |
| ZnO | 0-5 | weight %; |
| TiO₂ | 0-2 | weight %; |
| CaO (CaSO₄) | 0.5-1.5 | weight %; |

and
a remaining balance of said weight % is said sulfate refining agent.

20. The method according to claim 1, wherein said glass product produced is an alkaline earth silicate glass having a composition in weight % on an oxide basis of:

| | | |
|---|---|---|
| SiO₂ | 65-75 | weight %; |
| Na₂O | 8-13 | weight %; |
| K₂O | 4-9 | weight %; |
| Al₂O₃ | 0-2 | weight %; |
| MgO | 0-4 | weight %; |
| CaO (Sum) | 4-9 | weight %; |
| BaO | 0-3 | weight %; |
| ZnO | 0-5 | weight %; |
| TiO₂ | 0-2 | weight %; |
| CaO (CaSO₄) | 0.5-1.5 | weight %; |

and
a remaining balance of said weight % is said sulfate refining agent.

21. The method according to claim 1, wherein said glass product produced is an alkaline earth silicate glass having a composition in weight % on an oxide basis of:

| | | |
|---|---|---|
| SiO₂ | 65-75 | weight %; |
| Na₂O | 8-10 | weight %; |
| K₂O | 6-9 | weight %; |
| CaO (Sum) | 4-9 | weight %; |
| BaO | 1-3 | weight %; |
| ZnO | 3-5 | weight %; |
| TiO₂ | 0-2 | weight %; |
| CaO (CaSO₄) | 0.5-1.5 | weight %; |

and
a remaining balance of said weight % is said sulfate refining agent.

22. The method according to claim 1, wherein a physical refining process is utilized instead of a chemical refining process, said physical refining process using low pressure.

23. The method according to claim 1, wherein contaminants from a plurality of raw materials and in the refining process are minimized.
